(19) United States
(12) Patent Application Publication
(10) Pub. No.: US 2006/0085109 A1
(43) Pub. Date: Apr. 20, 2006

(54) Method for activating function variants

(76) Inventors: Ulrich Freund, Stuttgart (DE); Nuria Mata Burgarolas, Stuttgart (DE); Alexander Burst, Karlsruhe (DE)

Correspondence Address: KENYON & KENYON LLP, ONE BROADWAY, NEW YORK, NY, 10004, US

(21) Appl. No.: 11/241,282

(22) Filed: Sep. 29, 2005

(30) Foreign Application Priority Data
Sep. 29, 2004 (DE) 102004047079.0

(51) Int. Cl. G06F 19/00

(52) U.S. Cl. 701/29; 340/438

(57) ABSTRACT

A method for activating functions of a certain application in which predefined functions are combined in a main function, possible linkages of these functions are established via variation points, executable program code is generated for all functions, and functions or their linkages are activated via programmable variation points. The method is particularly suitable for testing function variants in a motor vehicle.

### FIELD OF THE INVENTION

The present invention relates to a method for activating function variants or functions of a certain application in which predefined function variants are combined in a main function and possible linkages of these function variants are established via variation points.

### BACKGROUND INFORMATION

In the following, reference is essentially made to the testing of function variants in a motor vehicle, without the method being restricted to this application.

Motor vehicle manufacturers offer a great number of different equipment component or function variants in their vehicles. The combination of individual equipment components or functions is referred to as equipment component or function variant. A considerable portion of these functions is electronics-based and requires appropriate software. This results in a tremendous number of different software variants, i.e., a combination of different software.

As a rule, not all theoretically possible function variants are requested by the customer in a uniformly distributed manner and also, as a rule, the test coverage does not achieve a uniform distribution. Subsequently, less frequently requested functions are less intensively tested which may result in malfunctions during later operation. These malfunctions are undesirable and should be avoided.

Physical E/E (electronic/electrical) architectures are designed in a motor vehicle for all possible function variants. The result of this approach is referred to in automotive engineering as 150% auto, whereas the software-based function variants are optimized toward the current variants.

In one variant, unneeded source program code is commented out prior to compilation via preprocessor definitions, i.e., compiler switches, and is no longer contained in the executable program code. Therefore, it is expensive to test all possible software-based function variants.

A method should be made available which makes it possible to provide different function variants in a simpler manner.

### SUMMARY OF THE INVENTION

In the method according to the present invention for activating functions of a certain application, predefined functions are combined in a main function, possible linkages of these functions are established via variation points, executable program code is generated for all functions, and functions or their linkages are activated via programmable variation points. Activation takes place, for example, by programming or configuring the programmable variation points.

In a preferred embodiment, all functions theoretically possible for the application are combined in the main function. This enables the advantageous generation of executable program code for all possible functions.

In the method according to the present invention, the functions or their linkages are advantageously activated via the programmable variation points according to a crisp logic. During activation according to a crisp logic, only one function at a time is activated at a variation point.

In the method according to the present invention, the functions or their linkages are just as advantageously activated via the programmable variation points according to a fuzzy logic (e.g., characteristics maps). During activation according to a fuzzy logic, multiple functions are activated at a variation point at predefined or random weighting ratios to one another.

Both activation logics yield a large number of function variants which in turn provides great test coverage in a simple manner.

In a preferred embodiment of the method, the executable program code is transferred to hardware, in particular experimental hardware or rapid prototyping systems, and the functions or their linkages are activated there via the programmable variation points. This allows simple and quick execution of variant tests on experimental hardware.

The functions or their linkages are advantageously activated via the programmable variation points using crossbar switches. The crossbar switch defines a connection scheme which interconnects the input and output values of functions on an experimental hardware system or a rapid prototyping system at runtime. The crossbar switch thus corresponds with the entirety of the connections which may be stretched between the functions contained in the modeling. The crossbar switch may be compared with a two-dimensional matrix in which both dimensions correspond to the function inputs and outputs and in which the matrix values define whether the appropriate inputs and outputs are connected to one another.

Use of the method according to the present invention is particularly preferred for testing function variants in a motor vehicle. This allows quick and simple testing of a plurality of function variants and equipment component variants of a motor vehicle.

It is understood that the above-mentioned features and the features to be explained in the following are not only usable in the described combination, but also in other combinations or as stand-alones without leaving the scope of the present invention.

### BRIEF DESCRIPTION OF THE DRAWINGS

FIG. 1 shows conventional function variants using a windshield wiper controller in a motor vehicle as an example.

FIG. 2 shows a preferred embodiment of the method according to the present invention.

### DETAILED DESCRIPTION

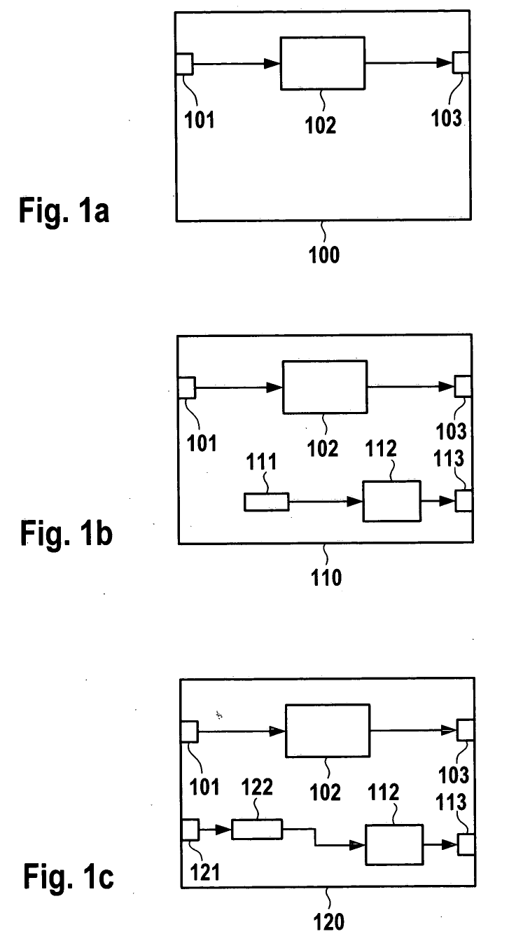

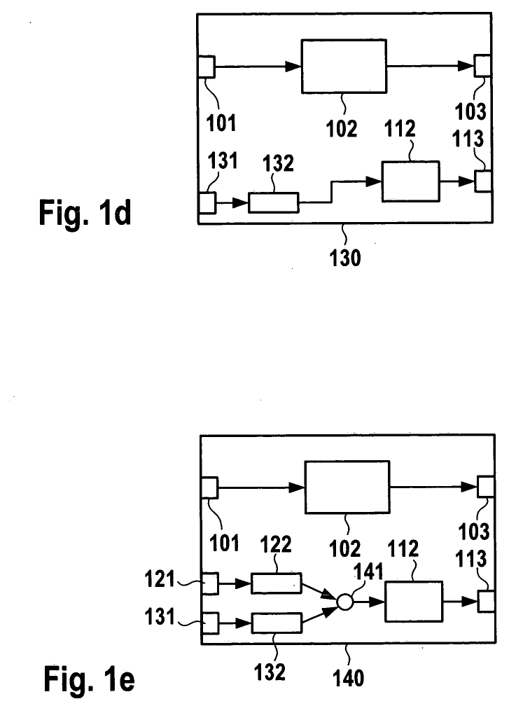

FIG. 1a shows a model of a conventional function variant of a windshield wiper controller in a motor vehicle. It is a controller model for the windshield wiper controller collectively indicated by reference numeral 100. The controller model has an input 101 relating to the setting of the wiper switch, a calculation function 102 and an output 103. It should be pointed out that calculation function 102 represents a function in terms of a mathematical method.

As a function of the position of the wiper switch, calculation function 102 calculates the control signals for the windshield wiper motor (not shown) necessary for the associated movement of the windshield wiper, the control signals being transmitted to the motor via output 103. This variant only allows the setting of a predefined wiper speed via the switch position.

FIG. 1b shows a further model 110 of a conventional function variant of a windshield wiper controller in a motor vehicle. An intermittent wiping function is additionally added in this variant to the function shown in FIG. 1a.

A predefined wipe interval 111 is conveyed to a calculation function 112. Calculation function 112 calculates the control signals necessary for the associated movement of the windshield wiper, the control signals being output via an output 113.

FIG. 1c shows model 120 of a further conventional function variant of a windshield wiper controller in a motor vehicle. As a function of the vehicle velocity, an intermittent wiping function is additionally added in this variant to the function shown in FIG. 1a. Model 120 again has the components of model 100 and, in addition, an input 121 relating to the vehicle velocity, a calculation function 122, and calculation function 112.

Values or signals relating to the vehicle velocity are conveyed to calculation function 122 via input 121. Calculation function 122 calculates from these values an associated wipe interval which is conveyed to calculation function 112. Calculation function 112 calculates the control signals necessary for the associated movement of the windshield wiper, the control signals being output via output 113.

FIG. 1d shows model 130 of a further conventional function variant of a windshield wiper controller in a motor vehicle. As a function of the rain intensity or the amount of rain, an intermittent wiping function is additionally added in this variant to the function shown in FIG. 1a. Model 130 again has the components of model 100 and, in addition, an input 131 relating to the amount of rain per time interval, a calculation function 132, and calculation function 112.

Values or signals relating to the amount of rain are conveyed to calculation function 132 via input 131. Calculation function 132 calculates from these values an associated wipe interval which is conveyed to calculation function 112. Calculation function 112 calculates the control signals necessary for the associated movement of the windshield wiper, the control signals being output via output 113.

FIG. 1e shows model 140 of a further conventional function variant of a windshield wiper controller in a motor vehicle. This model combines the components of the models described in FIGS. 1c and 1d. A merge or combination calculation function 141 is additionally added in this variant.

Values or signals relating to the amount of rain are conveyed to calculation function 132 via input 131. Calculation function 132 calculates from these values an associated wipe interval which is conveyed to combination calculation function 141.

Values or signals relating to the vehicle velocity are conveyed to calculation function 122 via input 121. Calculation function 122 calculates from these values an associated wipe interval which is also conveyed to combination calculation function 141.

According to predefined calculation rules, combination calculation function 141 calculates from both received wipe intervals a combination wipe interval which is conveyed to calculation function 112. Calculation function 112 calculates the control signals necessary for the associated movement of the windshield wiper, the control signals being output via output 113.

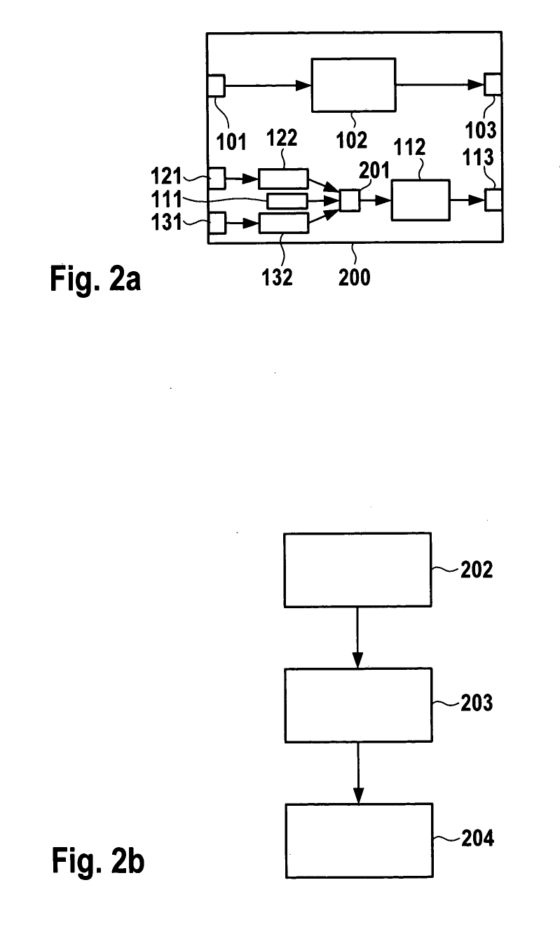

FIG. 2a schematically shows the first and second method steps of a method according to the present invention using the example of the above-described wiper controller. A model of a main function is indicated using reference numeral 200. All possible functions of the above-described wiper controller are combined in this main function.

Model 200 has input 101 relating to the setting of the wiper switch, calculation function 102, output 103, predefined wipe interval 111, calculation function 112, output 113, input 121 relating to the vehicle velocity, calculation function 122, input 131 relating to the amount of rain per time interval, and calculation function 132. A possible linkage of the functions is established via programmable variation point 201.

FIG. 2b shows the further steps of an exemplary embodiment of a method according to the present invention as a continuation of the above-described example. Executable program code is generated from the defined main function in third step 202. This program code includes all previously defined functions.

The executable program code is subsequently transferred to experimental hardware in following method step 203.

Finally, the intended function is activated on the experimental hardware in method step 204 by correspondingly setting the programmable variation point.

What is claimed is:

1. A method for activating functions of an application, comprising:
combining predefined functions in a main function;
establishing possible linkages of the predefined functions via variation points;
generating executable program code for all of the functions; and
activating at least one of (a) the predefined functions and (b) the linkages via programmable variation points.

2. The method according to claim 1, wherein all of the functions theoretically possible for the application are combined in the main function.

3. The method according to claim 1, wherein the at least one of (a) the predefined functions and (b) the linkages are activated via the programmable variation points according to a crisp logic.

4. The method according to claim 1, wherein the at least one of (a) the predefined functions and (b) the linkages are activated via the programmable variation points according to a fuzzy logic.

5. The method according to claim 1, further comprising transferring the executable program code to hardware, and wherein the at least one of (a) the predefined functions and (b) the linkages are activated there via the programmable variation points.

6. The method according to claim 5, wherein the hardware includes experimental hardware.

7. The method according to claim 5, wherein the hardware includes rapid prototyping systems.

8. The method according to claim 1, wherein the at least one of (a) the predefined functions and (b) the linkages are activated via the programmable variation points using crossbar switches.

9. The method according to claim 1, wherein the method is for testing function variants in a motor vehicle.
